(19) United States
(12) Patent Application Publication
(10) Pub. No.: US 2001/0037257 A1
(43) Pub. Date: Nov. 1, 2001

(54) Group bulk purchase system using network

(76) Inventors: Toru Niki, Yokohama-shi (JP); Masayuki Yoshida, Yokohama-shi (JP); Masayuki Sakura, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/818,603

(22) Filed: Mar. 28, 2001

(30) Foreign Application Priority Data
Mar. 30, 2000 (JP) 2000-094385

(51) Int. Cl. G06F 17/60

(52) U.S. Cl. 705/26; 705/14

(57) ABSTRACT

In systems for purchasing products through a network, when purchasers makes a group for purchasing products in bulk, a system is provided that makes it easy for each member of the bulk purchase group and the seller of the products to use the group bulk purchase. For this purpose, when a person makes a request for a group bulk purchase, ID for the group bulk purchase is issued. When the purchase using this ID satisfies a predetermined condition, a special favor is given to each person who has requested the purchase.

### BACKGROUND OF THE INVENTION

1. Field of the Invention

The present invention relates to group bulk purchase systems for selling products with a volume discount, and performing a so-called group bulk purchase.

2. Related Background Art

In a conventional product selling method with a volume discount (bulk purchase), the purchaser side specifies the members of the bulk purchase group when requesting a bulk purchase of products, and the seller side sells the products with adding a special favor in advance upon delivery of the products and settlement of payments for the products.

In case of such a prior art as described above, however, the purchaser side must confirm the members of the bulk purchase group before requesting the bulk purchase. Besides, all the members must purchase the products at the same time. For these reasons, there was a disadvantage that raising the members of the bulk purchase group was difficult.

On the other hand, the seller side also had the following disadvantage. That is, since the products were delivered with adding the special favor in advance, even if a member of the bulk purchase group suddenly cancelled the purchase, the products have been sold with adding the special favor even though the bulk purchase has been broken off.

### SUMMARY OF THE INVENTION

The present invention was made for solving the above problem of the prior art, and aims to provide a group bulk purchase system that makes it easy for each purchaser who wants to purchase a product through a group bulk purchase and a seller who wants to sell products through a bulk purchase to use the group bulk purchase.

In order to attain the above object, a group bulk purchase system according to the present invention comprises at least one bulk purchase group management server and at least one terminal connected with each other through a network, wherein said bulk purchase group management server, when receiving, from said terminal, a request for a group bulk purchase indicating purchase conditions including at least the name and the number of products to be purchased, notifies said terminal of given ID uniquely corresponding to said group bulk purchase, makes storage means store the purchase state corresponding to said group bulk purchase, updates said purchase state stored in said storage means when a purchase of the product designated in said group bulk purchase is performed using said given ID, and gives a special favor on the basis of the purchase state stored in said storage means.

A bulk purchase group management server according to the present invention is connected with at least one terminal through a network, wherein said bulk purchase group management server is notified from said terminal of a request for a group bulk purchase indicating purchase conditions including at least the name and the number of products to be purchased, and said bulk purchase group management server, when receiving the request for said group bulk purchase, notifies said terminal of given ID uniquely corresponding to said group bulk purchase, makes storage means store the purchase state corresponding to said group bulk purchase, updates said purchase state stored in said storage means when a purchase of the product designated in said group bulk purchase is performed using said given ID, and gives a special favor on the basis of the purchase state stored in said storage means.

A terminal according to the present invention is connected through a network with a bulk purchase group management server that, when receiving a request for a group bulk purchase, notifies said terminal of given ID uniquely corresponding to said group bulk purchase, makes storage means store the purchase state corresponding to said group bulk purchase, updates said purchase state stored in said storage means when a purchase of the product designated in said group bulk purchase is performed using said given ID, and gives a special favor on the basis of the purchase state stored in said storage means, wherein said terminal is used for, when making a request for a group bulk purchase to said bulk purchase group management server, notifying said bulk purchase group management server of the request for the group bulk purchase including purchase conditions including at least the name and the number of products to be purchased.

A group bulk purchase method according to the present invention comprises the steps of: opening, to public, the contents of a group bulk purchase in relation to products to be sold; making a request for said group bulk purchase opened; purchasing said products corresponding to said group bulk purchase; and managing the purchase state of said group bulk purchase on the basis of the purchase of said products, and giving a special favor to each member of said group bulk purchase in accordance with said purchase state.

A special favor giving program according to the present invention for giving a special favor to each member of a group bulk purchase, comprises the steps of: receiving a request for the group bulk purchase input when making the request for said group bulk purchase and indicating purchase conditions including at least the name and the number of products to be purchased; notifying given ID uniquely corresponding to said group bulk purchase when receiving the request for said group bulk purchase; making storage means store the purchase state corresponding to said group bulk purchase; updating said purchase state stored in said storage means when a purchase of the product designated in said group bulk purchase is performed using said given ID; and giving the special favor on the basis of the purchase state stored in said storage means.

A recording medium recording thereon a special favor giving program according to the present invention for giving a special favor in a group bulk purchase, comprises the steps of: receiving a request for the group bulk purchase input when making the request for said group bulk purchase and indicating purchase conditions including at least the name and the number of products to be purchased; notifying given ID uniquely corresponding to said group bulk purchase when receiving the request for said group bulk purchase; making storage means store the purchase state corresponding to said group bulk purchase; updating said purchase state stored in said storage means when a purchase of the product designated in said group bulk purchase is performed using said given ID; and giving the special favor on the basis of the purchase state stored in said storage means.

A selling system according to the present invention comprises: means for opening the definition of a group bulk purchase to public; means for receiving a declaration of said group bulk purchase; means for receiving an order from each member of said group bulk purchase; and means for calculating a special favor in accordance with the definition of said group bulk purchase and the state of said order, wherein the special favor calculated by said means for calculating the special favor is given to each member when the order from the last member of said group bulk purchase has completed, or when a purchase period has elapsed.

### BRIEF DESCRIPTION OF THE DRAWINGS

FIG. 1 is a representation showing an outline of the whole of a group bulk purchase system according to an embodiment of the present invention;

FIG. 2 is a representation showing an operation sequence of the system of FIG. 1;

FIG. 3 is a block diagram showing the internal construction of a bulk purchase group management server shown in FIGS. 1 and 2;

FIG. 4 is a block diagram showing the internal construction of a client shown in FIG. 3;

FIG. 5 is a flowchart of an operation of the group bulk purchase system according to the embodiment;

FIG. 6 is a flowchart of another operation of the group bulk purchase system according to the embodiment;

FIG. 7 is a flowchart of still another operation of the group bulk purchase system according to the embodiment;

FIG. 8 is a discount rate table for each product stored in a data base of the bulk purchase group management server shown in FIG. 3;

FIG. 9 is a purchase group ID table used in the group bulk purchase system according to the embodiment and issued by the bulk purchase group management server when a request for a bulk purchase is issued, for identifying each purchaser and the group that the purchaser belongs to;

FIG. 10 is a purchase condition management table for each bulk purchase group, used in the group bulk purchase system according to the embodiment;

FIG. 11 is a view showing an example of UI displayed on the computer of a purchaser (a leader of a bulk purchase group) upon “accessing to discount information” in FIG. 2;

FIG. 12 is a view showing an example of UI displayed on the computer of the purchaser (the leader of the bulk purchase group) upon “obtaining of discount information” in FIG. 2; and

FIG. 13 is a view showing an example of UI displayed on the computer of the purchaser (the leader of the bulk purchase group) upon “request for bulk purchase” in FIG. 2.

### DETAILED DESCRIPTION OF THE PREFERRED EMBODIMENT

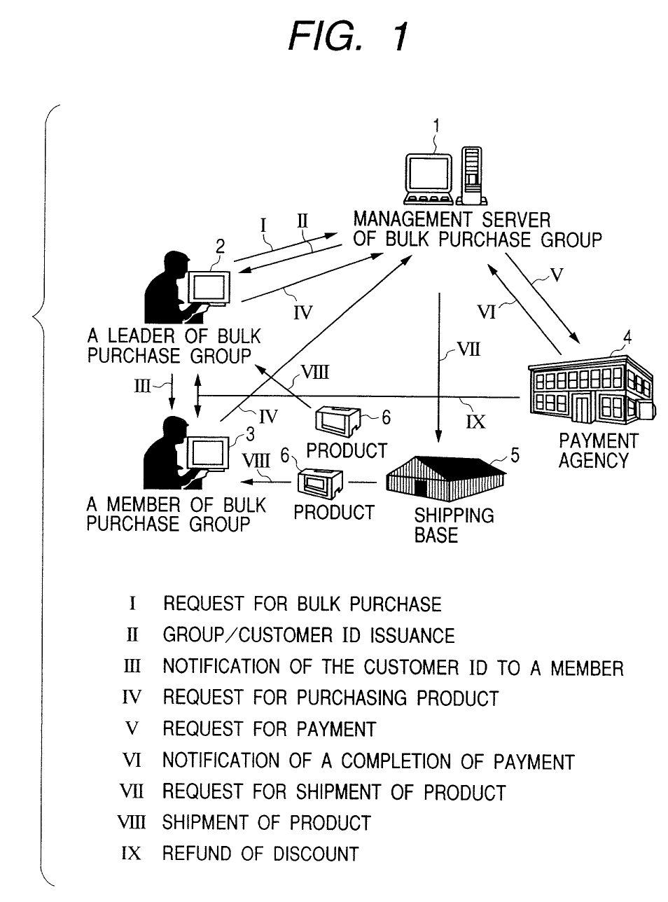

Hereinafter, a group bulk purchase system according to an embodiment of the present invention will be described with reference to FIGS. 1 to 13. The below description includes the description of each embodiment of a bulk purchase group management server, a terminal, a group bulk purchase method, a special favor giving program, a recording medium recording thereon the special favor giving program, and a selling system according to the present invention.

An outline of the whole of the group bulk purchase system according to this embodiment will be described first with reference to FIG. 1. FIG. 1 shows an outline of the whole of the group bulk purchase system according to this embodiment.

Referring to FIG. 1, the group bulk purchase system of this embodiment includes a bulk purchase group management server 1, a personal computer 2 of a leader of a bulk purchase group, a personal computer 3 of a member of the bulk purchase group, a payment agency 4, and a shipping base 5, which are connected with one another through a network.

In the group bulk purchase system of this embodiment, however, the respective numbers of bulk purchase group management servers 1, personal computers 2 and 3, payment agencies 4, and shipping bases 5 are not limited to those shown in FIG. 1. They can be changed freely.

The bulk purchase group management server 1, the personal computers 2 and 3 of the leader and member of the bulk purchase group, which computers serve as terminals of this embodiment, the payment agency 4, and the shipping base 5 may be connected through the same kind or different kinds of network lines.

For example, the connection between the bulk purchase group management server 1 and the personal computers 2 and 3 of the leader and member of the bulk purchase group may be made through Internet, and the connection between the bulk purchase group management server 1 and the payment agency 4 and the connection between the bulk purchase group management server 1 and the shipping base 5 may be made through the respective exclusive lines. The network connecting between the spots may be wired or wireless.

The bulk purchase group management server 1 has a homepage in its WWW server. The homepage includes the contents of each bulk purchase, and is open to public.

The contents of each bulk purchase includes the name of product intended for the bulk purchase, the conditions of the bulk purchase, a special favor obtained when the bulk purchase is concluded, and so on.

The conditions of a bulk purchase are to require a purchaser or a group of purchasers to purchase, e.g., ten certain products within two months. The seller can freely set up the conditions of each bulk purchase, e.g., the contents or kinds of the conditions (e.g., the number of products).

The personal computer 2 is used by a leader of a bulk purchase group. The leader of the bulk purchase group is the person to make a request for the bulk purchase. He or she may actually purchase the product through the bulk purchase or only make the request for the bulk purchase.

The personal computer 3 is used by a member of the bulk purchase group. The member of the bulk purchase group is a person who joins in the bulk purchase group to purchase the product actually. The number of members can freely be changed in accordance with the bulk purchase group to be made.

The payment agency 4 is a service for payment and reception of money, such as a bank, a credit card company, a post office, or a telephone office. Various methods for payment are thinkable, e.g., payment at a window, on-line banking, issuance of a transfer paper, sending a negotiable instrument such as a check or a postage stamp.

The shipping base 5 ships the products 6 to the purchasers of the products 6 on the basis of instructions of the bulk purchase group management server 1.

The operation of the system shown in FIG. 1 will be described next. First, a person (a leader of a bulk purchase group) who wants to purchase a product through a group bulk purchase accesses the bulk purchase group management server 1 through his or her personal computer 2 to make a request for a bulk purchase (I).

When receiving the request, the bulk purchase group management server 1 give the leader of the bulk purchase group a group/customer ID, which is a given ID of the present invention, for identifying the group and the purchasers (customers) belonging to the group (II).

The leader of the bulk purchase group informs each bulk purchase group member of the customer ID given to the purchasers of the bulk purchase (III).

Each member of the bulk purchase group given the customer ID accesses the bulk purchase group management server 1 using the customer ID as a key for identifying him or her, and requests the purchase of the product intended for the bulk purchase (IV).

When receiving the purchase request from each member of the bulk purchase group, the bulk purchase group management server 1 requests the payment agency 4 to settle the payment for the purchase (V).

The payment agency 4 requested to settle the payment takes out money corresponding to the price of the product from a designated account of the member of the bulk purchase group, and transfers the money to an account designated by the bulk purchase group management server 1, in practice, an account of the seller of the product. When the money transfer is completed, the payment agency 4 sends a notification of completion of payment to the bulk purchase group management server 1 (VI).

When receiving the notification of completion of payment from the payment agency 4, the bulk purchase group management server 1 requests the shipping base 5 to ship the product 6 to the corresponding member of the bulk purchase group who has requested the purchase of the product (VII).

When receiving the request from the bulk purchase group management server 1 to ship the product, the shipping base 5 ships the product 6 to each member of the bulk purchase group whose payment has been settled (VIII).

At the same time, the bulk purchase group management server 1 manages the purchase condition of the members of the bulk purchase group in this bulk purchase process. When the purchase condition reaches a predetermined condition, a special favor is given to the leader and each member of the bulk purchase group (IX).

The system shown in FIG. 1 exemplifies a case wherein reaching the above predetermined condition is achievement of the conditions of a bulk purchase. But, it is not limited to this, for example, the number of purchased products within a predetermined period, or the period till a predetermined number of products are purchased is usable.

Giving the special favor is performed by the manner that the bulk purchase group management server 1 requests the payment agency 4 to transfer a predetermined amount of money, as shown by IX in FIG. 1. The special favor is a discount obtained by multiplying the price of the product by a predetermined discount rate. The above is an outline of the operation of this embodiment.

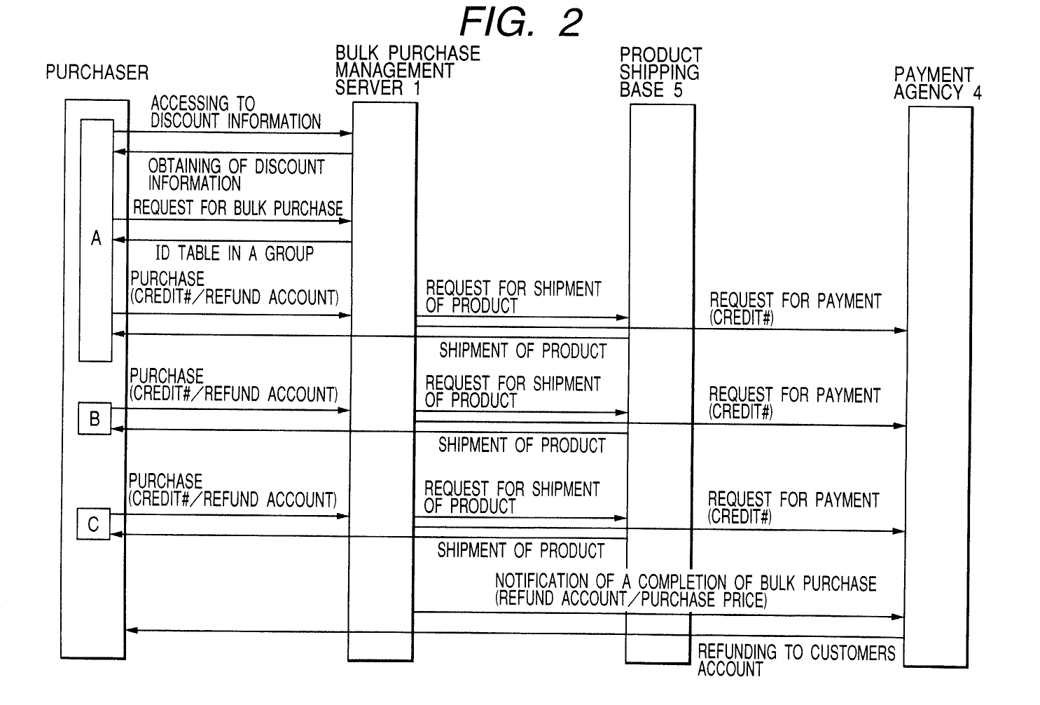

The detail of the operation of each part shown in FIG. 1 will be described next with reference to FIG. 2. FIG. 2 shows an operation sequence of the system of FIG. 1.

First, the leader A of the bulk purchase group as a purchaser through the bulk purchase accesses discount information (bulk purchase information) in the bulk purchase group management server 1. The discount information includes the bulk purchase information and other discount information (e.g., discount information in a bargain sale period).

In response to the access, the bulk purchase group management server 1 transmits the discount information to the leader A of the bulk purchase group.

The leader A of the bulk purchase group checks the discount information obtained. After checking, when he or she decided a bulk purchase, he or she sends a request for the bulk purchase to the bulk purchase group management server 1. The above corresponds to Action I in FIG. 1.

When receiving the request for the bulk purchase, the bulk purchase group management server 1 transmits a group ID table corresponding to the bulk purchase, to the leader A of the bulk purchase group (Action II in FIG. 1). When receiving the group ID, the leader A of the bulk purchase group allots the group ID to each of the members B and C of the bulk purchase group (Action III in FIG. 1).

Each of the members B and C of the bulk purchase group allotted ID sends a request with ID for purchasing the product intended for the bulk purchase to the bulk purchase group management server 1 (Action IV in FIG. 1). At this time, he or she designates a payment method for settling the payment of the price of the product and for receiving a discount as a special favor. In the example shown in FIG. 2, he or she designates payment by a credit card. Of course, he or she can designate another method such as transfer from and to his or her bank account.

When receiving the request for purchasing the product, the bulk purchase group management server 1 requests the payment agency 4 to settle the payment (Actions V and VI in FIG. 1), and requests the shipping base 5 to ship the product (Action VII in FIG. 1).

When receiving the request to ship the product, the shipping base 5 ships the product 6 to each purchaser who has requested the purchase of the product (Action VIII in FIG. 1).

At this time, the bulk purchase group management server 1 that received the request for purchasing the product updates a purchase condition table for this bulk purchase.

Referring to the updated purchase condition table, the bulk purchase group management server 1 judges as to whether or not the purchase condition of this group has achieved a predetermined condition (e.g., condition that a predetermined number of products are purchased within a predetermined period).

When this group has achieved the condition of the bulk purchase, the bulk purchase group management server 1 judges that the bulk purchase has completed, and sends, as a notification of completion of bulk purchase, a request for giving a special favor, to the payment agency 4. At this time, the payment agency 4 may be informed also of an account for refund and an amount of money to be refunded.

When receiving the request for giving the special favor, the payment agency 4 refunds the designated amount of money for each purchaser (Action IX in FIG. 1).

As described above, the operation of the bulk purchase is completed.

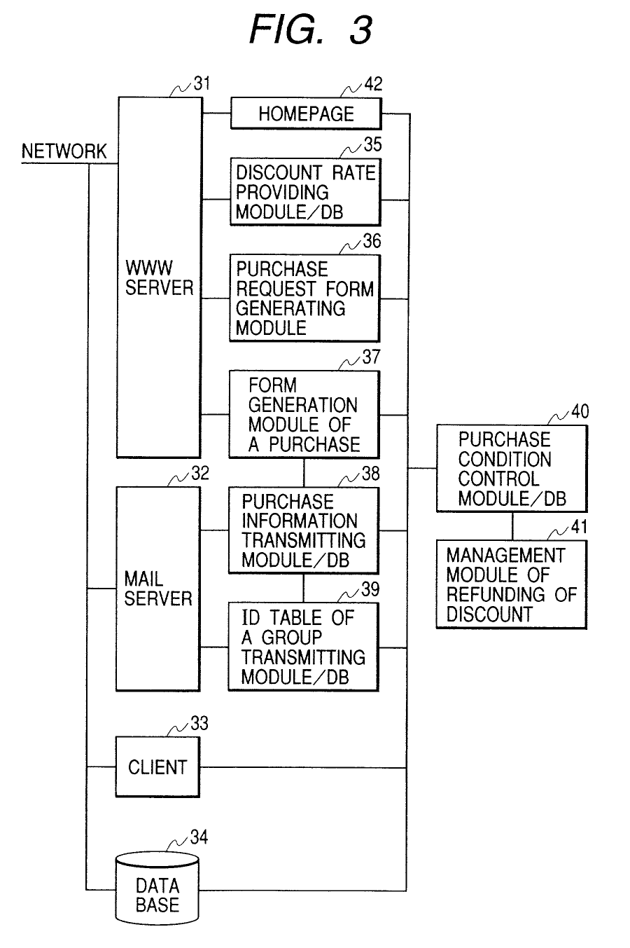

The internal construction of the bulk purchase group management server 1 shown in FIGS. 1 and 2 will be described next with reference to FIG. 3. FIG. 3 schematically shows the internal construction of the bulk purchase group management server 1 shown in FIGS. 1 and 2.

Referring to FIG. 3, the bulk purchase group management server 1 comprises, as its principal components, a WWW server 31 as means for making a definition of bulk purchase of the present invention open to public, means for receiving a declaration of a bulk purchase, means for receiving an order from each group purchaser, and means for calculating a special favor, a mail server 32, a client 33, and a data base (DB) 34. These components are connected with one another through a LAN.

The WWW server 31 stores, in its site, a page (homepage) described in a language in HTML form or the like, in general. The homepage is linked with homepages in other WWW servers connected through a network by HTTP.

In this embodiment, the homepage stored in the WWW server 31 includes discount information for products to be sold. Therefore, the user of each terminal connected with the WWW server 31 through a network (e.g., Internet using TCP/IP) can access the discount information for products anytime from any place.

The WWW server 31 receives a request for a bulk purchase and a request for purchasing a product from a leader and each purchaser of a bulk purchase group.

The mail server 32 transmits information to be given to each purchaser, by e-mail. Information to be given includes ID and so on as described above. The WWW server 31, the mail server 32, and the data base 34 may be managed using hosting, housing, or the like, other than the case wherein they are managed originally by the seller side.

The client 33 makes various settings of the WWW server 31, the mail server 32, and the data base 34. That is, the client 33 serves as a host for controlling the operation of each of the WWW server 31, the mail server 32, and the data base 34.

The data base stores information input to the WWW server 31 and information transmitted by the mail server 32.

The operation of each components shown in FIG. 3 will be described next. As described above, the WWW server 31 stores the homepage 42 and makes it open to public.

The WWW server 31 uses a discount rate providing module 35 for determining a discount rate and showing it, a purchase request form generating module 36 for generating a form for receiving a request for a bulk purchase, and a purchase form generating module 37 for generating a form for receiving a request for purchasing a product.

The discount rate providing module 35 refers to a discount rate providing data base (DB) stored in the data base 34.

The mail server 32 is provided with a purchase information transmitting module 38 for transmitting information indicating in what purchase condition each bulk purchase is at present, and a group ID table transmitting module 39 for transmitting ID to each group.

The purchase information transmitting module 38 refers to the discount rate providing data base (DB) stored in the data base 34.

The client 33 makes setting controls for various modules, and setting controls for the WWW server 31, the mail server 32, and the data base 34. The client 33 man ages purchase conditions with a purchase condition control module 40, and manages refund conditions of discounts with a refunding discount management module 41. Data of each purchase condition is stored in the data base 34, and the client refers to and updates the purchase condition properly.

As described above, the data base 34 functions as a data base for providing a discount rate, a data base for transmitting purchase information, a data base for transmitting a group ID table, and a data base for purchase conditions.

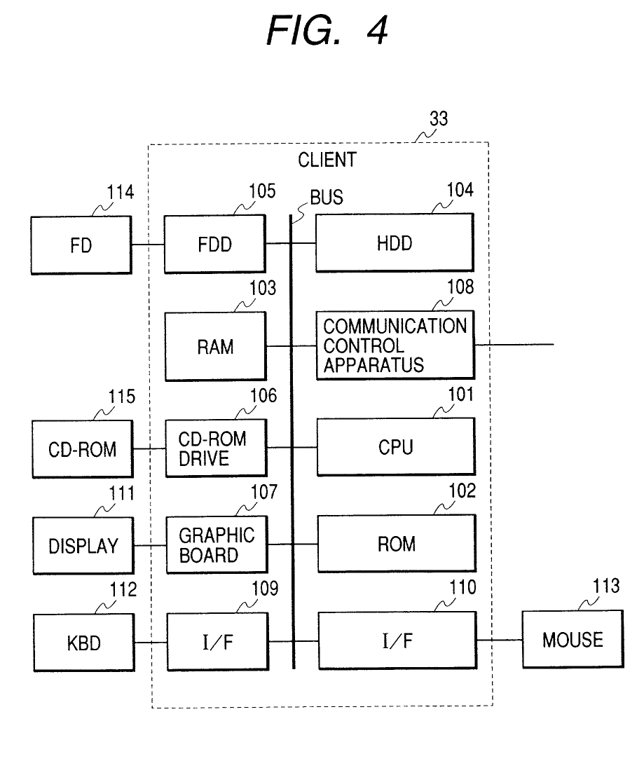

The internal construction of the client 33 shown in FIG. 3 will be described next with reference to FIG. 4. FIG. 4 is a block diagram showing the internal construction of the client 33 shown in FIG. 3.

Referring to FIG. 4, the client 33 comprises a CPU (Central Processing Unit) 101, a ROM (Read Only Memory) 102, a RAM (Random Access Memory) 103, a hard disk drive (HDD) 104, a floppy disk drive (FDD) 105, a CD-ROM drive 106, a graphic board 107, a communication control apparatus 108, and interface circuits (I/F) 109 and 110, which are connected with one another through a bus.

With the graphic board 107 connected is a display 111 such as a cathode ray tube (CRT) or a liquid crystal display (LCD).

With the I/F 109 connected with a keyboard (KBD) 112. With the I/F 110 connected with a mouse 113 or another pointing device such as a track ball, a flat space, or a joy stick.

The ROM 102 stores a starting program. The starting program is executed by the CPU 101 when the client 33 is powered on. By this, an operating system (OS) and one or more drivers for display processing or communication processing, stored in the HDD 104, are loaded to the RAM 103, and thereby various processes and controls become possible to be executed.

On the RAM 103 developed is a program for controlling the client 33. The RAM 103 holds a processing result by the program, temporary data for processing, display data for displaying the processing result or the like on a screen of the display 111, and so on, and it is used as a work area of the CPU 101.

The display data developed on the RAM 103 is transmitted to the display 111 through the graphic board 107. The display 111 displays, on its screen, display contents (text, image, etc.) corresponding to the display data.

The HDD 104 is a device for recording programs, control data, text data, image data, etc., on its hard disk, or reading out them from its hard disk, following instructions of the CPU 101.

The FDD 105 is a device for recording programs, control data, text data, image data, etc., on a floppy disk (FD) 114, or reading out them from the floppy disk, following instructions of the CPU 101.

The CD-ROM drive 106 is a device for reading out programs and data recorded on a CD-ROM (a read only memory using a compact disc) 115, following instructions of the CPU 101.

The communication control apparatus executes exchanging data between it and another device, and down-loading a program or data, using a communication line connected to the client 33, following instructions of the CPU 101.

The KBD 112 is provided with a plurality of keys (character input keys, cursor keys, etc.), and used for an operator inputting data into the client 33.

The mouse 113 is used for inputting a selecting instruction using a mouse cursor displayed on the display 111.

The CPU 101 executes various programs stored in the ROM 102, the HDD 104, the FD 114, and the CD-ROM 115, gives instructions to each components in the client 33, and controls the operations of the client 33 and its peripheral devices.

Programs and data held in a recording medium such as the hard disk may be held in advance, or programs and data down-loaded from another device may be held.

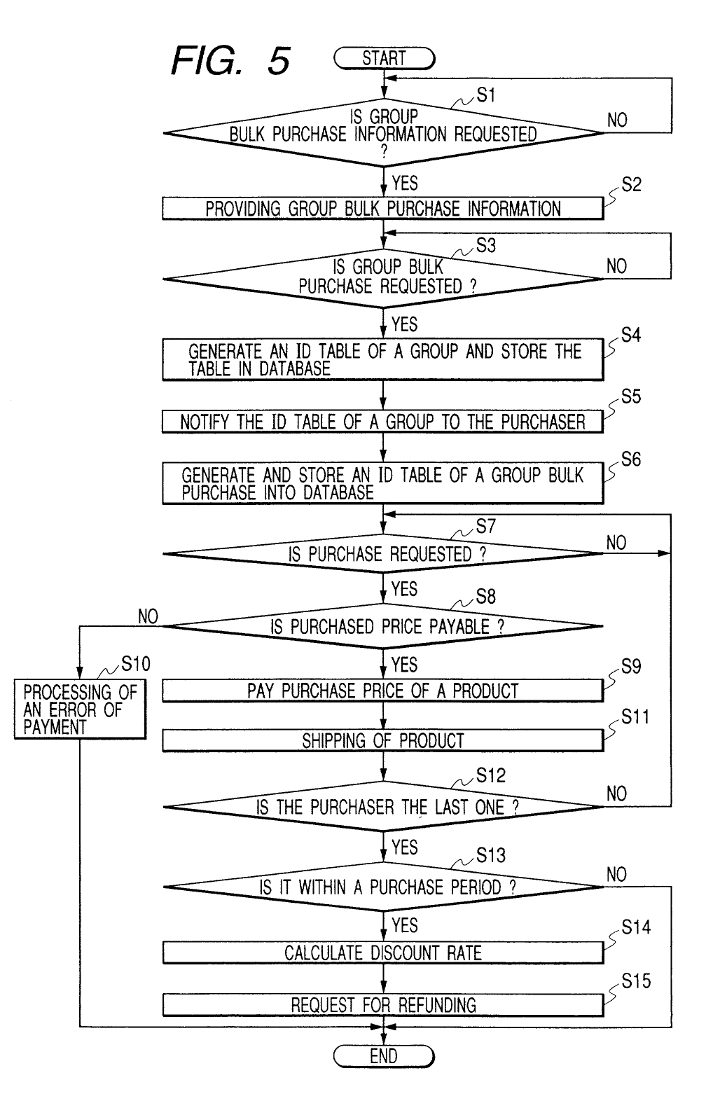

The operations of the group bulk purchase system according to this embodiment will be described next with reference to FIGS. 5 to 7. FIGS. 5 to 7 each show a flowchart of the operation of an embodiment of the group bulk purchase system according to the present invention.

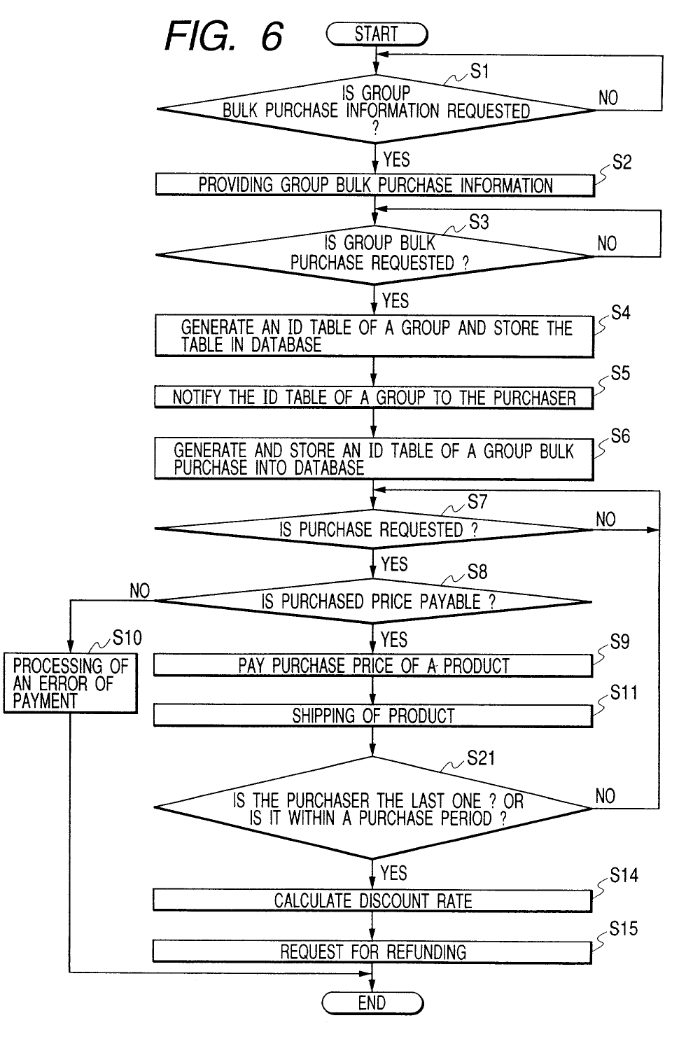

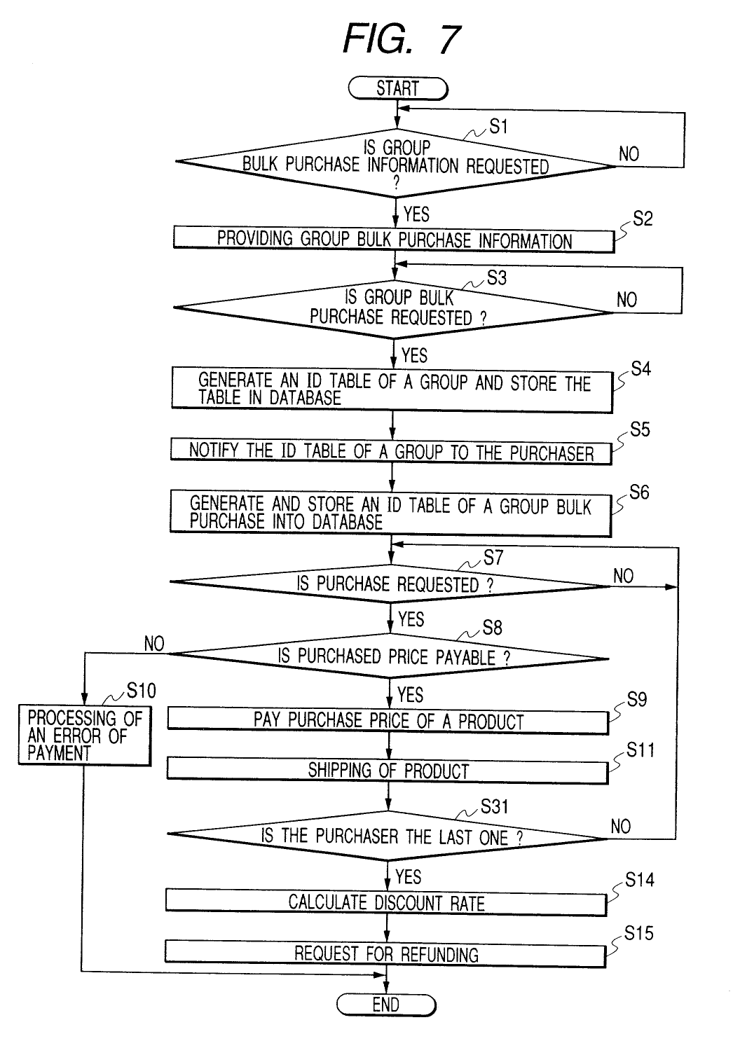

The flowchart of FIG. 5 shows an example wherein a special favor is given only when all purchasers have purchased products within a purchase period. The flowchart of FIG. 6 shows an example wherein, even when all purchasers have not purchased the products within the purchase period, the special favor is given in accordance with the number of purchasers. The flowchart of FIG. 7 shows an example wherein, if the period when all purchasers have completed their purchases is shorter or longer than the purchase period declared first, the special favor is given in accordance with the case.

(Operation for giving a special favor only when all purchasers have purchased products within a period) The operation shown in the flowchart of FIG. 5 will be described first. The bulk purchase group management server 1 judges as to whether or not group bulk purchase information is requested by a leader of a bulk purchase group (step S1).

When the group bulk purchase information is requested (YES), the bulk purchase group management server 1 provides the group bulk purchase information on the personal computer 2 of the leader of the bulk purchase group (step S2), and then waits for a request for a group bulk purchase (step S3).

When a group bulk purchase is requested (YES), the bulk purchase group management server 1 generates a group ID table, and stores it in the data base 34 (step S4).

The bulk purchase group management server 1 then notifies the generated group ID table to the purchaser (the leader of the bulk purchase group) (step S5).

Next, the bulk purchase group management server 1 generates a management table for the group bulk purchase requested, and stores it in the data base 34 (step S6).

The bulk purchase group management server 1 then waits for a request for purchasing a product from a purchaser (step S7).

When a purchase of a product is requested (YES), the bulk purchase group management server 1 inquires the payment agency 4 whether or not the purchase price is payable (step S8). When it is not payable (NO), the bulk purchase group management server 1 performs processing of an error of payment in step S10, and then ends its operation.

When it is payable (YES), the bulk purchase group management server 1 request the payment agency 4 to settle the payment of the purchase price of the product (step S9), and instructs the shipping base 5 to ship the product (step S11).

Next, the bulk purchase group management server 1 judges as to whether or not the purchaser who has requested the purchase is the last member of the bulk purchase group (step S12). This judgment is made, e.g., on the basis of data in the data base 34 by counting the members of the bulk purchase group who have purchased the products, or judging as to whether or not purchasing the products has been performed using all given ID.

When the purchaser is not the last (NO), the flow returns to step S7. When the purchaser is the last (YES), the flow advances to step S13, wherein the bulk purchase group management server 1 judges as to whether or not the time when the last purchaser purchased the product is within the purchase period declared in the group bulk purchase.

When it is not within the purchase period (NO), the bulk purchase group management server 1 ends its operation at this time. When it is within the purchase period, the bulk purchase group management server 1 calculates a discount rate (step S14), and requests the payment agency 4 to refund the calculated discount (step S15).

As described above, in case of the operation shown in the flowchart of FIG. 5, the special favor (refund of discount) is given only when the condition of a group bulk purchase is achieved within a predetermined period.

(Operation for giving a special favor in accordance with the number of purchasers even when all purchasers have not purchased products within a period)

The operation shown in the flowchart of FIG. 6 will be described next. In the flowchart shown in FIG. 6, processing from steps S1 to S11 and in steps S14 and S15 is the same as that in the flowchart shown in FIG. 5 as described above, so its description is omitted here.

In this operation, after requesting the shipping base 5 to ship the product, the bulk purchase group management server 1 judges in step S21 as to whether or not the purchaser is the last, or whether or not the purchase is out of a purchase period.

When the purchaser is not the last or the purchase is within the purchase period (NO), the flow returns to step S7.

When the purchaser is the last or the purchase is out of the purchase period (YES), the flow advances to step S14.

That is, in this operation, after the purchase period elapsed, even when the number of purchasers is below that declared in the group bulk purchase, the bulk purchase group management server 1 calculates a discount rate (step S14), and requests the payment agency 4 to refund the discount (step S15).

It is administratively suitable that the discount to be refund in this case increases in proportion to the number of actual purchasers and is less than that when all members of the bulk purchase group have purchased the products within the predetermined period. But it may be equal to or exceed the discount to be refund when all members of the bulk purchase group have purchased the products within the predetermined period.

(Operation for giving a special favor in accordance with the period when all members of a bulk purchase group have purchased products)

The operation shown in the flowchart of FIG. 7 will be described next. In the flowchart shown in FIG. 7, processing from steps S1 to S11 and in steps S14 and S15 is the same as that in the flowchart shown in FIG. 5 as described above, so its description is omitted here.

In this operation, after requesting the shipping base 5 to ship the product, the bulk purchase group management server 1 judges in step S31 as to whether or not the purchaser is the last.

When the purchaser is not the last (NO), the flow returns to step S7.

When the purchaser is the last (YES), the flow advances to step S14.

That is, in this operation, irrespective of the time when the last purchaser purchases the product, in case that the number of purchasers declared in the group bulk purchase has been attained, the bulk purchase group management server 1 calculates a discount rate (step S14), and requests the payment agency 4 to refund the discount (step S15).

But it is suitable that the discount to be refund in this case is increased or decreased in accordance with the time when the last purchaser purchased the product.

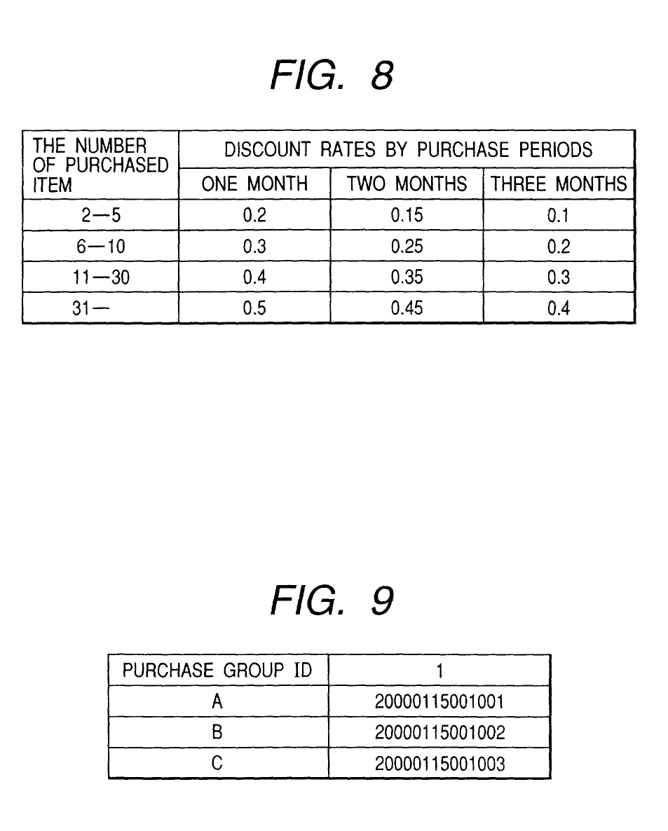

An example of discount rate table used in this embodiment will be described next with reference to FIG. 8. FIG. 8 shows a discount rate table for each product stored in the data base 34 of the bulk purchase group management server 1 shown in FIG. 3.

As shown in FIG. 8, the discount rate of each product varies in accordance with the number of products purchased through the group bulk purchase, and the purchase period.

For example, when the number of purchased products and the purchase period are three and two months, respectively, the discount rate is 0.15. That is, when three products A were purchased within two months, a discount of 0.15 Y (Y: the purchase price of the product) is refunded. The other cases are similar to this.

In the example of FIG. 8, the more the number of purchased products is or the shorter the purchase period is, the more the discount rate is. But the discount rate is not limited to this. It can freely be set.

In calculating a period for purchasing products, as the start time of the period usable is any of the time when a leader of a bulk purchase group sends a request for a group bulk purchase to the bulk purchase group management server 1, the time when ID is given to the leader of the bulk purchase group by the bulk purchase group management server 1 in response to the request for the group bulk purchase from the leader of the bulk purchase group, the time when the first member of the bulk purchase group sends a request for purchasing a product, and a time set by the seller of the products, or a combination of some of them.

Also in calculating the period for purchasing the products, as end time of the period usable is any of a time designated in the group bulk purchase, the time when the last member of the bulk purchase group purchases the product, and a time set by the seller of the products, or a combination of some of them.

As a unit of period usable is any of second, minute, hour, day, week, month, and year, or a combination of some of them.

Purchase group ID issued by the bulk purchase group management server 1 to a leader of a bulk purchase group when the leader of the bulk purchase group sends a request for a group bulk purchase to the bulk purchase group management server 1 will be described next with reference to FIG. 9. FIG. 9 shows a purchase group ID table used in this embodiment and issued by the bulk purchase group management server 1 when a request for a group bulk purchase is issued, for identifying each purchaser and the group that the purchaser belongs to.

Referring to FIG. 9, the purchase group ID for this group is “1”, and ID values for purchasers A, B, and C are “20000115001001”, “20000115001002”, and “20000115001003”, respectively. Of course, these ID values are by way of example. The figures, giving algorism, or the like, can freely be changed.

The ID value for each purchaser is unique in the bulk purchase group management server 1. By a purchaser only informing the bulk purchase group management server 1 of his or her ID value when sending a request for purchasing a product, the bulk purchase group management server 1 can know the group that the purchaser belongs to.

The purchase group ID table is stored in the data base 34 shown in FIG. 3.

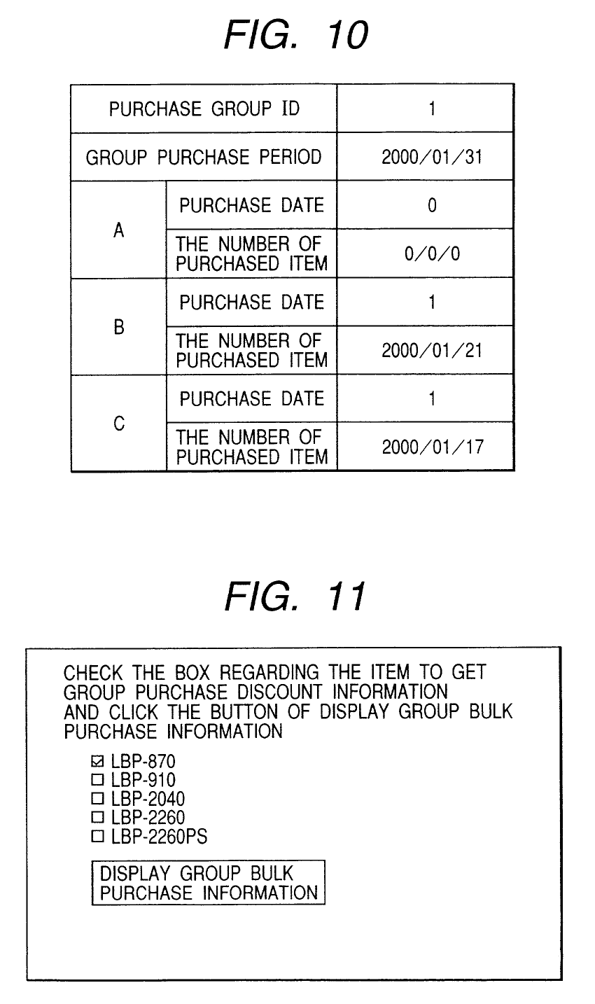

A purchase condition management table for each bulk purchase group generated when the bulk purchase group management server 1 receives a request for a group bulk purchase and the group bulk purchase starts will be described next with reference to FIG. 10. FIG. 10 is a purchase condition management table for each bulk purchase group, used in this embodiment.

The table shown in FIG. 10 includes purchase group ID, a group purchase period, and the number of purchased item and the purchase date of each purchaser. The number of purchased item and the purchase date of each purchaser are initially set at “0” and “0/0/0”, respectively. They are updated when each purchaser actually purchases the product.

The purchase condition management table for each bulk purchase group is stored in the data base 34 shown in FIG. 3.

Windows (User Interface: hereinafter to be simply referred to as UI) shown on the displays of the personal computers 2 and 3 when a leader and each member of a bulk purchase group perform input operations for a group bulk purchase with their personal computers 2 and 3 will be described next with reference to FIGS. 11 to 13.

Referring first to FIG. 11, an example of UI displayed on the personal computer of a purchaser (the leader of the bulk purchase group) upon “accessing to discount information” in FIG. 2 will be described.

FIG. 11 shows a window for selecting a piece of group purchase discount information. One of various items, i.e., “LBP-870”, “LBP-910”, etc., can be selected by clicking the corresponding check box.

Of course, selection of products of the present invention is not limited to the example shown in FIG. 11. The number or kinds of products may freely be changed. Besides, the product selecting method is not limited to clicking a check box. It may be input of each product name.

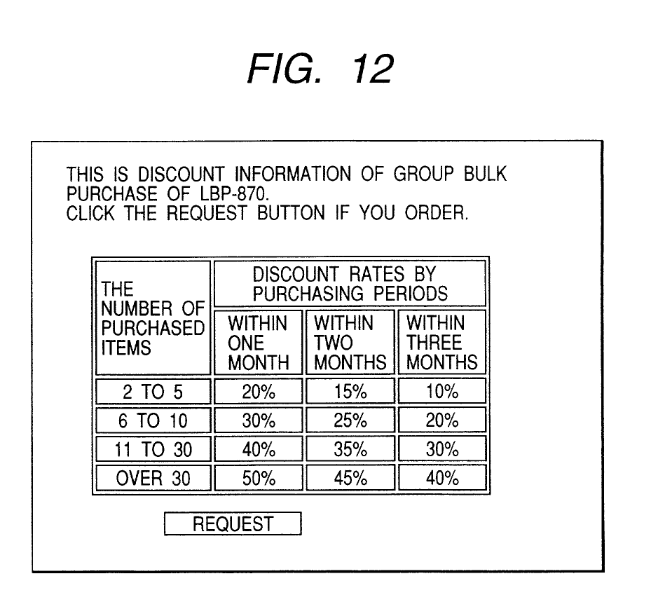

Referring next to FIG. 12, an example of UI displayed on the personal computer of a purchaser (the leader of the bulk purchase group) upon “obtaining of discount information” in FIG. 2 will be described.

In FIG. 12 shown is discount information for each product. This information corresponds to the discount rate table for each product described before in connection with FIG. 8.

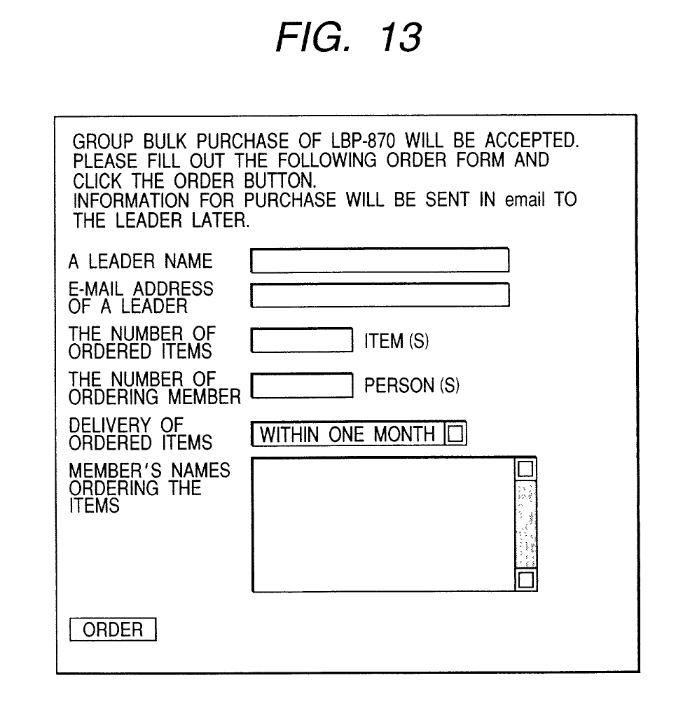

Referring next to FIG. 13, an example of UI displayed on the personal computer of a purchaser (the leader of the bulk purchase group) upon “request for bulk purchase” in FIG. 2 will be described.

In the example shown in FIG. 13, the name and e-mail address of the leader of the bulk purchase group is input as information for identifying the leader of the bulk purchase group.

Besides, conditions of the group bulk purchase can be input. Further, the number of products designated to be purchased, the number of purchasers, a purchase period, and the names of all purchasers can be input.

Of course, the data to be input upon “request for bulk purchase” is not limited to that shown in FIG. 13. For example, in case of receiving a service wherein a special favor is given in accordance with the period when all purchasers have purchased products, as shown in the flowchart of FIG. 7 described before, any purchase period need not be input.

As described above, in this embodiment, a leader of a bulk purchase group makes a declaration of the number of purchasers and a purchase period and a request for a group bulk purchase. The shipping base 5 delivers products at their normal price upon delivery and payment.

The bulk purchase group management server 1 makes instructions to pay a special favor, when the purchasers have purchased the products as the initial declaration. Therefore, since it suffices that the purchasers have purchased the products within a certain period, it becomes easy to raise members of the bulk purchase group. On the other hand, since the seller side can pay the special favor when the group bulk purchase has actually completed, there is no fear that the special favor was paid though the group bulk purchase has not completed.

In the above embodiment, when making a request for a group bulk purchase, a leader of a bulk purchase group informs the bulk purchase group management server 1 of each purchaser who joins in the bulk purchase group. On the basis of this information, the bulk purchase group management server 1 gives each purchaser unique ID as shown in FIG. 9 for example.

However, the group bulk purchase system according to the present invention is not limited to such a case. For example, when making a request for a group bulk purchase, the leader of the bulk purchase group may inform the bulk purchase group management server 1 of not each purchaser who joins in the bulk purchase group, but only the request of the group bulk purchase (the number of products to be purchased, or the like). In this case, the operation is as follows.

First, in response to such a request, the bulk purchase group management server 1 gives the leader of the bulk purchase group an ID value uniquely corresponding to the request for the group bulk purchase.

The leader of the bulk purchase group distributes the given ID value to each purchaser.

Each purchaser then accesses the bulk purchase group management server 1 using the given ID value to make a request for purchasing a product.

Since the ID value uniquely corresponds to the group bulk purchase, the bulk purchase group management server 1 can manage the condition of the group bulk purchase, like the above-described embodiment. That is, even in this case, the same effect as in the above-described embodiment can be obtained.

In the above embodiment, the bulk purchase group management server 1 and the personal computers 2 and 3 are connected with each other through a network. But the present invention is not limited to such a case, and various modifications can be made therein.

For example, in the above embodiment, the purchaser side performs a request of a group bulk purchase, the purchase of products, etc., with personal computers. However, these can also be performed with postal cards, request papers, or the like, or by oral request, e-mail, or the like.

Besides, as a medium for transmitting information between the purchaser and seller sides, a network is exemplified. Other than this, for example, a postal service, a delivery service, telephones, or the like, is usable in accordance with the above-described postal cards, request papers, oral request, or the like.

Besides, in the above embodiment, the bulk purchase group management server 1 performs management of purchase conditions, reception of purchases, etc. Alternatively, such management of purchase conditions, reception of purchases, etc., may be performed manually, e.g., by recording them on notes or the like.

Besides, in the above embodiment, the contents of each group bulk purchase is open to public through the WWW server 31 as a homepage. Other than this, the contents of each group bulk purchase may be open to public through advertisements on newspapers, magazines, TV, or the like. The contents may be transmitted to each purchaser by e-mail. A direct mail may be sent to each purchaser to open the contents of each group bulk purchase.

As described above, according to the present invention, when a special favor is given to a group bulk purchase requested by a leader of a bulk purchase group, not products are sold with adding the special favor in advance as the prior art, but the special favor is given later in accordance with the condition of completion of the group bulk purchase. Therefore, for the leader and members of the bulk purchase group, the disadvantage that full members of the bulk purchase group must be raised can be released. On the other hand, the seller of the products intended for the group bulk purchase can provide a stable product purchase service irrespective of whether or not the group bulk purchase is completed.

What is claimed is:

1. A group bulk purchase system comprising at least one bulk purchase group management server and at least one terminal connected with each other through a network,
wherein said bulk purchase group management server,
when receiving, from said terminal, a request for a group bulk purchase indicating purchase conditions at least including a name and a number of products to be purchased, notifies said terminal of given ID uniquely corresponding to said group bulk purchase, makes storage means store a purchase state corresponding to said group bulk purchase, updates said purchase state stored in said storage means when a purchase of the product designated in said group bulk purchase is performed using said given ID, and gives a special favor on the basis of the purchase state stored in said storage means.

2. A system according to claim 1, wherein said special favor is a discount of the purchase price of the product designated in said group bulk purchase.

3. A system according to claim 1, wherein said special favor is given to each member of said group bulk purchase.

4. A system according to claim 1, wherein said bulk purchase group management server gives said special favor after the group bulk purchase received is completed.

5. A system according to claim 1, wherein said purchase conditions include a purchase period of said product.

6. A system according to claim 1, wherein said purchase conditions include a payment method for said group bulk purchase, and
said bulk purchase group management server performs payment or reception of money by a method designated by said payment method upon at least one of cases of selling said product and of giving said special favor.

7. A system according to claim 1, wherein said purchase conditions include a payment method for each member of said group bulk purchase, and
said bulk purchase group management server performs payment or reception of money between it and each member by a method designated by said payment method upon at least one of cases of selling said product and of giving said special favor.

8. A system according to claim 1, wherein the contents of said group bulk purchase are open to public through a homepage provided in a site of a WWW server.

9. A bulk purchase group management server connected with at least one terminal through a network, wherein
said bulk purchase group management server is notified from said terminal of a request for a group bulk purchase indicating purchase conditions at least including a name and a number of products to be purchased, and
said bulk purchase group management server,
when receiving the request for said group bulk purchase, notifies said terminal of given ID uniquely corresponding to said group bulk purchase, makes storage means store a purchase state corresponding to said group bulk purchase, updates said purchase state stored in said storage means when a purchase of the product designated in said group bulk purchase is performed using said given ID, and gives a special favor on the basis of the purchase state stored in said storage means.

10. A terminal connected through a network with a bulk purchase group management server that, when receiving a request for a group bulk purchase, notifies said terminal of given ID uniquely corresponding to said group bulk purchase, makes storage means store the purchase state corresponding to said group bulk purchase, updates said purchase state stored in said storage means when a purchase of the product designated in said group bulk purchase is performed using said given ID, and gives a special favor on the basis of the purchase state stored in said storage means, wherein said terminal is used for, when making a request for a group bulk purchase to said bulk purchase group management server, notifying said bulk purchase group management server of the request for the group bulk purchase including purchase conditions including at least the name and the number of products to be purchased.

11. A group bulk purchase method comprising the steps of:
opening, to public, the contents of a group bulk purchase in relation to products to be sold;
making a request for said group bulk purchase opened;
purchasing said products corresponding to said group bulk purchase; and
managing a purchase state of said group bulk purchase on the basis of the purchase of said products, and giving a special favor to each member of said group bulk purchase in accordance with said purchase state.

12. A special favor giving program for giving a special favor to each member of a group bulk purchase, comprising the steps of:
receiving a request for the group bulk purchase input when making the request for said group bulk purchase and indicating purchase conditions at least including a name and a number of products to be purchased;
notifying given ID uniquely corresponding to said group bulk purchase when receiving the request for said group bulk purchase;
making storage means store the purchase state corresponding to said group bulk purchase;
updating said purchase state stored in said storage means when a purchase of the product designated in said group bulk purchase is performed using said given ID; and
giving the special favor on the basis of the purchase state stored in said storage means.

13. A recording medium recording thereon a special favor giving program for giving a special favor in a group bulk purchase, comprising the steps of:
receiving a request for the group bulk purchase input when making the request for said group bulk purchase and indicating purchase conditions at least including a name and a number of products to be purchased;
notifying given ID uniquely corresponding to said group bulk purchase when receiving the request for said group bulk purchase;
making storage means store a purchase state corresponding to said group bulk purchase;
updating said purchase state stored in said storage means when a purchase of the product designated in said group bulk purchase is performed using said given ID; and
giving the special favor on the basis of the purchase state stored in said storage means.

14. A selling system comprising:
means for opening the definition of a group bulk purchase to public;
means for receiving a request from said group bulk purchase;
means for receiving an order from each member of said group bulk purchase; and
means for calculating a special favor in accordance with the definition of said group bulk purchase and a state of said order,
wherein the special favor calculated by said means for calculating the special favor is given to each member when the order from the last member of said group bulk purchase has completed, or when a purchase period has elapsed.

15. A system according to claim 14, wherein said means for receiving the request of said group bulk purchase receives information capable of identifying a purchase period, the number of products to be purchased, and all purchasers when receiving the request of said group bulk purchase.

16. A system according to claim 14, further comprising a data base for storing group bulk purchase information received through said means for receiving an order.

17. A system according to claim 14, wherein said means for calculating the special favor generates a purchase condition management table made up from information for identifying a purchaser, a purchase period, and a purchase date.

18. A system according to claim 17, wherein said means for receiving an order updates said purchase condition management table at the time when the order of an purchaser is completed.
